(19) United States
(12) Patent Application Publication
(10) Pub. No.: US 2026/0342253 A1
(43) Pub. Date: Oct. 29, 2026

(54) MTPA CONTROL METHOD AND RELATED DEVICE FOR PERMANENT MAGNET SYNCHRONOUS MOTOR

(71) Applicants: Ningbo Institute of Materials Technology and Engineering, Chinese Academy of Sciences, Ningbo (CN); University of Nottingham Ningbo China, Ningbo (CN)

(72) Inventors: Xinmin CHEN, Ningbo (CN); Gelin WANG, Ningbo (CN); He ZHANG, Ningbo (CN); Weiduo ZHAO, Ningbo (CN)

(73) Assignees: Ningbo Institute of Materials Technology and Engineering, Chinese Academy of Sciences, Ningbo (CN); University of Nottingham Ningbo China, Ningbo (CN)

(21) Appl. No.: 19/329,453

(22) Filed: Sep. 15, 2025

(30) Foreign Application Priority Data
Apr. 28, 2025 (CN) 202510548022X

(51) Int. Cl. H02P 21/12; H02P 21/00; H02P 101/30

(52) U.S. Cl. CPC H02P 21/12; H02P 21/0014; H02P 2101/30; H02P 2207/05

(57) ABSTRACT

An MTPA control method and a related device for a permanent magnet synchronous motor are provided, belonging to the field of motor control technology. The method includes: establishing the current angle objective function of the motor to be controlled; performing a polynomial fitting on the current angle objective function of the motor to be controlled to obtain a polynomial description of the current angle objective function; explicitly describing the polynomial description of the current angle objective function according to the Kolmogorov-Arnold Networks to obtain an optimal current angle of the motor to be controlled; and inputting the optimal current angle of the motor to be controlled to the MTPA control module of the motor to be controlled, and performing MTPA control on the motor to be controlled. The present disclosure realizes accurate calculation of the optimal current angle and accurate control of the dynamic performance of the motor.

### CROSS-REFERENCE TO RELATED APPLICATIONS

The application claims priority to Chinese patent application No. 202510548022X, filed on Apr. 28, 2025, the entire contents of which are incorporated herein by reference.

### TECHNICAL FIELD

The present disclosure belongs to the field of motor control technology, and particularly relates to a maximum torque per ampere (MTPA) control method and a related device for a permanent magnet synchronous motor.

### BACKGROUND

The permanent magnet synchronous motor (PMSM) is a synchronous motor that uses permanent magnets to generate magnetic fields. It plays a vital role in the electrical field. Especially in the field of electric aviation, PMSM has become a preferred motor type for electric aircraft due to its low energy consumption, fast response acceleration performance, and extended flight endurance. Depending on positions of permanent magnet materials on a motor rotor, PMSMs can be divided into inner-mounted permanent magnet synchronous motor (IPMSM) and surface-mounted permanent magnet synchronous motor (SPMSM). Compared to SPMSM, IPMSM has higher torque and power density and a wider speed adjustment range, giving it an advantage in the field of electric aircraft.

At present, the control over PMSMs generally includes zero direct-axis current (ZDC) control strategy and maximum torque per ampere (MTPA) control strategy. Since the electromagnetic torque in a permanent magnet synchronous motor is mainly related to the direct axis (d-axis) current, while the reluctance torque is related to both the d-axis current and the quadrature axis (q-axis) current, therefore, the ZDC control strategy will cause the reluctance torque to drop to zero, thereby reducing the output torque.

In contrast, the MTPA control strategy optimizes the ratio of d-axis current to q-axis current to maximize electromagnetic torque output under a constant stator current magnitude. Therefore, as an efficient control technology, the MTPA control strategy is widely used in the field of electric aircraft to ensure a minimum copper loss of permanent magnet synchronous motors during operation, thereby improving overall operating efficiency and flight stability, and bringing excellent performance and efficiency to the drive system of the electric aircraft.

One objective of the MTPA control strategy is to find an optimal current angle to maximize the torque produced by a motor under a given amount of stator current. Among them, the optimal current angle is called the MTPA angle. When a PMSM is actually running, the working point of the MTPA angle will change with factors such as temperature, magnetic saturation, and external disturbance. In view of this, in the prior art, parameter-based methods and search-based methods are generally adopted to obtain MTPA angles, but the above methods rely heavily on complex mathematical models and signal injection techniques, and have problems such as low computational efficiency, poor interpretability, and difficulty in scaling. Specifically, for the parameter-based method, the computing is performed based on equations and formulas, being highly dependent on the availability of precise parameters and extremely susceptible to specific operating conditions and environmental factors of an electric aircraft. For the search-based method, the computing relies on iterative optimization or is obtained by injecting virtual high-frequency signals, which has a low computational speed and requires a large amount of computing resources.

### SUMMARY

In view of the technical problems existing in the prior art, the present disclosure provides an MTPA control method and a related device for a permanent magnet synchronous motor to solve the technical problems that the method for obtaining the MTPA angle in the prior art relies heavily on complex mathematical models and signal injection technology, has low computational efficiency, poor interpretability, and difficulty in scaling.

To achieve the above objective, the present disclosure provides the following technical solutions:

The present disclosure provides an MTPA control method for a permanent magnet synchronous motor, including:
acquiring an electromagnetic torque and a stator current of a motor to be controlled;
establishing a current angle objective function of the motor to be controlled with the goal of maximizing the ratio of the electromagnetic torque to the stator current of the motor to be controlled;
performing a polynomial fitting on the current angle objective function of the motor to be controlled based on Taylor expansion to obtain a polynomial description of the current angle objective function;
explicitly describing the polynomial description of the current angle objective function according to the Kolmogorov-Arnold Networks to obtain an interpretable objective function;
solving the interpretable objective function to obtain an optimal current angle of the motor to be controlled; and
performing MTPA control on the motor to be controlled based on the optimal current angle of the motor to be controlled.

Further, the process of acquiring an electromagnetic torque and a stator current of a motor to be controlled includes:
establishing MTPA control logic rules of the motor to be controlled according to the nonlinear equation of the motor to be controlled; and
acquiring an electromagnetic torque and a stator current of a motor to be controlled based on a preset current angle test value according to the MTPA control logic rules of the motor to be controlled.

Further, the nonlinear equation of the motor to be controlled includes the steady-state voltage equation of the motor to be controlled and the torque equation of the motor to be controlled;
the steady-state voltage equation of the motor to be controlled is as follows:

$${u}_{d} = {R}_{s} {i}_{d} + {L}_{d} ( {i}_{d} , {i}_{q} ) \frac{{di}_{d}}{dt} - {pw}_{m} {L}_{q} ( {i}_{d} , {i}_{q} ) {i}_{q}$$

$${u}_{q} = {R}_{s} {i}_{q} + {L}_{q} ( {i}_{d} , {i}_{q} ) \frac{{di}_{q}}{dt} + {pw}_{m} {L}_{d} ( {i}_{d} , {i}_{q} ) {i}_{d} + {pw}_{m} {φ}_{f} ( {i}_{d} , {i}_{q} )$$

$${i}_{d} = - {i}_{s} sin θ$$

$${i}_{q} = {i}_{s} cos θ$$

where u_{d} is the equivalent voltage of the motor to be controlled on the direct axis; Rₛ is the stator resistance of the motor to be controlled; i_{d} is the equivalent current of the motor to be controlled on the direct axis; L_{d} is the equivalent inductance of the motor to be controlled on the direct axis; i_{q} is the equivalent current of the motor to be controlled on the quadrature axis; t is the time; p is the number of pole pairs of the motor to be controlled; wₘ is the mechanical rotor speed of the motor to be controlled; L_{q} is the equivalent inductance of the motor to be controlled on the quadrature axis; u_{q} is the equivalent voltage of the motor to be controlled on the quadrature axis; φ_{f} is the permanent magnet flux linkage of the motor to be controlled; iₛ is the stator current of the motor to be controlled; θ is the current angle of the motor to be controlled; L_{d}(i_{d},i_{q}) is a mapping of the equivalent inductance L_{d} of the motor to be controlled on the direct axis with respect to the equivalent current i_{d} of the motor to be controlled on the direct axis and the equivalent current i_{q} of the motor to be controlled on the quadrature axis; L_{q}(i_{d},i_{q}) is a mapping of the equivalent inductance L_{q} of the motor to be controlled on the quadrature axis with respect to the equivalent current i_{d} of the motor to be controlled on the direct axis and the equivalent current i_{q} of the motor to be controlled on the quadrature axis; and φ_{f}(i_{d},i_{q}) is a mapping of the permanent magnet flux linkage φ_{f} of the motor to be controlled with respect to the equivalent current i_{d} of the motor to be controlled on the direct axis and the equivalent current i_{q} of the motor to be controlled on the quadrature axis; and
the torque equation of the motor to be controlled is as follows:

$${T}_{e} = \frac{3}{2} p \{ {φ}_{f} ( {i}_{d} , {i}_{q} ) {i}_{q} + [ {L}_{d} ( {i}_{d} , {i}_{q} ) - {L}_{q} ( {i}_{d} , {i}_{q} ) ] {i}_{d} {i}_{q} \}$$

$${T}_{e} = 1.5 {pi}_{s} ( {φ}_{f} cos θ - 0.5 ( {L}_{d} - {L}_{q} ) {i}_{s} sin 2 θ )$$

where Tₑ is the electromagnetic torque of the motor to be controlled.

Further, the current angle objective function of the motor to be controlled is as follows:

$$\{ \begin{matrix}f ( θ ) = \frac{{T}_{e}}{{i}_{s}} \\ {max}_{θ} \frac{{T}_{e}}{{i}_{s}} \\ s . t . 0 \leq θ \leq π / 2\end{matrix}$$

where f(θ) is the current angle objective function of the motor to be controlled; θ is the current angle of the motor to be controlled; Tₑ is the electromagnetic torque of the motor to be controlled; and iₛ is the stator current of the motor to be controlled; max_{θ}

$$\frac{{T}_{e}}{{i}_{s}}$$

is when the current angle θ of the motor to be controlled takes a certain value, the ratio of the electromagnetic torque Tₑ of the motor to be controlled to the stator current is of the motor to be controlled is the largest.

Further, the polynomial description of the current angle objective function is as follows:

$$f ( θ ) = \frac{{T}_{e}}{{i}_{s}} = {a}_{k} {θ}^{k} + {a}_{k - 1} {θ}^{k - 1} + … + {a}_{1} θ + {a}_{0} , θ ∈ [ 0 , \frac{π}{2} ]$$

where aₖ is the coefficient of the k-order expansion term in the polynomial description of the current angle objective function; aₖ₋₁ is the coefficient of the k−1-order expansion term in the polynomial description of the current angle objective function; a₁ is the coefficient of the first-order expansion term in the polynomial description of the current angle objective function; a₀ is the coefficient of the zeroth-order expansion term in the polynomial description of the current angle objective function; k is the expansion order, and k∈[0, k]; θ^{k} is the kth power of the current angle θ of the motor to be controlled; and θ^{k-1} is the k−1th power of the current angle θ of the motor to be controlled.

Further, the interpretable objective function is as follows:

$$g ( θ ) = \frac{{T}_{e}}{{i}_{s}} = {b}_{1} {θ}^{3} + {b}_{2} sin ( θ ) + {b}_{3} exp ( θ ) , θ ∈ [ 0 , \frac{π}{2} ]$$

where g(θ) is the interpretable objective function; b₁ is a parameter describing the baseline of the current angle objective function; b₂ is a parameter describing the harmonic and periodic behavior of the motor model; b₃ is a parameter describing the magnetic saturation effect of the motor model; θ³ is the 3rd power of the current angle θ of the motor to be controlled.

Further, the process of solving the interpretable objective function to obtain an optimal current angle of the motor to be controlled includes:
solving a first-order derivative of the interpretable objective function to obtain the first-order derivative of the objective function with respect to the current angle; and
letting the first-order derivative of the objective function with respect to the current angle be zero, and calculating the optimal current angle for the motor to be controlled.

The present disclosure further provides an MTPA control system for a permanent magnet synchronous motor, including:
a data acquisition module, configured for acquiring an electromagnetic torque and a stator current of a motor to be controlled;
a function building module, configured for establishing a current angle objective function of the motor to be controlled with the goal of maximizing the ratio of the electromagnetic torque to the stator current of the motor to be controlled;
a polynomial description module, configured for performing a polynomial fitting on the current angle objective function of the motor to be controlled based on Taylor expansion to obtain a polynomial description of the current angle objective function;
an explicit description module, configured for explicitly describing the polynomial description of the current angle objective function according to the Kolmogorov-Arnold Networks to obtain an interpretable objective function;
a function solving module, configured for solving the interpretable objective function to obtain an optimal current angle of the motor to be controlled; and
an input control module, configured for performing MTPA control on the motor to be controlled based on the optimal current angle of the motor to be controlled.

The present disclosure further provides an electronic device, including:
a processor, suitable for executing computer programs; and
a computer-readable storage medium; the computer-readable storage medium stores a computer program, and when the computer program is executed by the processor, the MTPA control method of the permanent magnet synchronous motor is executed.

The present disclosure further provides a computer-readable storage medium. The computer-readable storage medium stores a computer program, and when the computer program is executed by the processor, the MTPA control method of the permanent magnet synchronous motor is realized.

Compared with the prior art, the beneficial effects of the present disclosure are as follows:

The present disclosure provides an MTPA control method for a permanent magnet synchronous motor. The Taylor expansion is used to perform a polynomial fitting on the current angle objective function of the motor to be controlled, and explicitly describes the polynomial description of the current angle objective function according to the Kolmogorov-Arnold Networks, thereby realizing accurate calculation of the optimal current angle of the motor to be controlled, and performing MTPA control on the motor to be controlled based on the optimal current angle. It can ensure that the direct axis current and quadrature axis current of the motor to be controlled are optimally distributed, and realize accurate control of the dynamic performance of the permanent magnet synchronous motor. The present disclosure does not require the inductance diagram or permanent magnet flux parameters of the motor, can effectively reduce the dependence on complex mathematical models and high-frequency signal injection, and has the advantages of strong interpretability, high scalability, high efficiency, and simplicity. Moreover, it can reduce the influence of motor parameter changes and enhance the robustness of the MTPA control method. It further improves load disturbance and transient response, further reduces copper loss, and improves the operating efficiency of permanent magnet synchronous motors.

The MTPA control system, electronic device, and computer-readable storage medium of the permanent magnet synchronous motor provided by the present disclosure have all the advantages of the preceding MTPA control method of the permanent magnet synchronous motor.

### BRIEF DESCRIPTION OF DRAWINGS

In order to more clearly illustrate the technical solutions in embodiments of the present application or the prior art, the following will briefly introduce the drawings required for the description of the embodiments or the prior art. Obviously, the drawings described below are only some embodiments of the present application. For those of ordinary skill in the art, other drawings can be obtained based on these drawings without creative work.

FIG. 1 is a flow chart of an MTPA control method of a permanent magnet synchronous motor provided in Embodiment 1.

FIG. 2 is a schematic diagram of a two-dimensional increase and decrease trend of a current angle in Embodiment 1.

FIG. 3 is a schematic diagram of a three-dimensional increase and decrease trend of the current angle in Embodiment 1.

FIG. 4 is a block diagram of an MTPA control system of a permanent magnet synchronous motor provided in Embodiment 2.

FIG. 5 is a block diagram of a structure of an electronic device provided in Embodiment 3.

### DETAILED DESCRIPTION OF THE EMBODIMENTS

In order to make the technical problems solved, technical solutions, and beneficial effects of the present application clearer, the following will combine the drawings in the embodiments of the present application to clearly and completely describe the technical solutions in the embodiments of the present application; obviously, the described embodiments are only some of the embodiments of the present application, not all of them. Based on embodiments of the present application, all other embodiments obtained by those of ordinary skill in the art without creative efforts shall fall within the protection scope of the present application.

The present disclosure provides an MTPA control method for a permanent magnet synchronous motor, including the following steps:

Step 100, acquiring an electromagnetic torque and a stator current of a motor to be controlled. Specifically, the motor to be controlled is a permanent magnet synchronous motor, and a Maximum Torque Per Ampere (MTPA) control module is provided in the motor to be controlled.

Step 200, establishing a current angle objective function of the motor to be controlled with the goal of maximizing the ratio of the electromagnetic torque to the stator current of the motor to be controlled.

Step 300, performing a polynomial fitting on the current angle objective function of the motor to be controlled based on Taylor expansion to obtain a polynomial description of the current angle objective function.

Step 400, explicitly describing the polynomial description of the current angle objective function according to the Kolmogorov-Arnold Networks (KANs) to obtain an interpretable objective function.

Step 500, solving the interpretable objective function to obtain an optimal current angle of the motor to be controlled.

Step 600, performing MTPA control on the motor to be controlled based on the optimal current angle of the motor to be controlled.

The present disclosure further provides an MTPA control system for a permanent magnet synchronous motor, including a data acquisition module, a function building module, a polynomial description module, an explicit description module, a function solving module, and an input control module.

The data acquisition module is configured for acquiring an electromagnetic torque and a stator current of a motor to be controlled; the function building module is configured for establishing a current angle objective function of the motor to be controlled with the goal of maximizing the ratio of the electromagnetic torque to the stator current of the motor to be controlled; the polynomial description module is configured for performing a polynomial fitting on the current angle objective function of the motor to be controlled based on Taylor expansion to obtain a polynomial description of the current angle objective function; the explicit description module is configured for explicitly describing the polynomial description of the current angle objective function according to the Kolmogorov-Arnold Networks to obtain an interpretable objective function; the function solving module is configured for solving the interpretable objective function to obtain an optimal current angle of the motor to be controlled; and the input control module is configured for performing MTPA control on the motor to be controlled based on the optimal current angle of the motor to be controlled.

The MTPA control method and system of the permanent magnet synchronous motor described in the present disclosure first establishes the current angle objective function of the motor to be controlled based on an electromagnetic torque and a stator current of the motor to be controlled, then uses Taylor expansion to perform a polynomial fitting on the current angle objective function of the motor to be controlled, and explicitly describes the polynomial description of the current angle objective function according to the Kolmogorov-Arnold Networks to obtain an interpretable objective function. Furthermore, by solving the interpretable objective function, an optimal current angle of the motor to be controlled can be accurately calculated. The MTPA control of the motor to be controlled is performed at the optimal current angle, which can ensure that the direct axis current and quadrature axis current of the motor to be controlled are optimally distributed, and realize accurate control of the dynamic performance of the permanent magnet synchronous motor.

In the present disclosure, when the polynomial description of the current angle objective function is explicitly described according to the Kolmogorov-Arnold Networks, the multilayer nonlinear activation function structure of the Kolmogorov-Arnold Networks can be used to fit the relationship between the optimal current angle and the motor parameters in a more intuitive way, thereby improving the interpretability of the current angle objective function of the motor to be controlled. Moreover, the architecture of the Kolmogorov-Arnold Networks allows for the addition or reduction of layers and neurons to accommodate motor control tasks of varying complexity, with high flexibility and scalability. In addition, the computational complexity and the required test data flow can be greatly reduced, so that an interpretable objective function can be quickly learned and fitted from a small amount of data, thereby reducing the number of real motor tests and costs of the motor to be controlled. Furthermore, it has real-time response control requirements and can quickly estimate an optimal current angle, which is suitable for the fast dynamic response requirements of permanent magnet synchronous motors in electric aircraft.

The following is a further explanation of the MTPA control method of the permanent magnet synchronous motor provided by the present disclosure with some specific embodiments:

### Embodiment 1

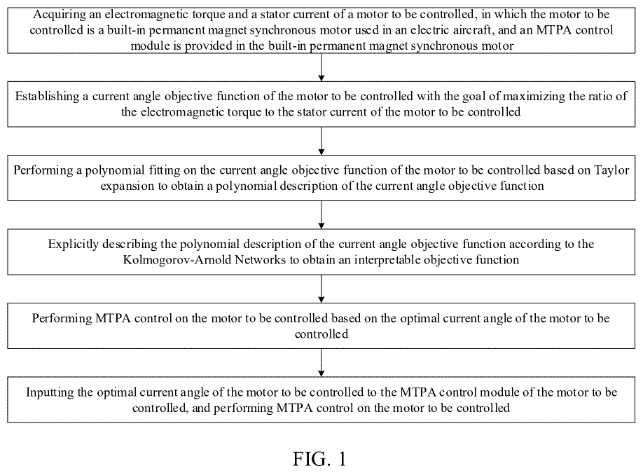

In Embodiment 1, the MTPA control process of a built-in permanent magnet synchronous motor applied to an electric aircraft is taken as an example; as shown in FIG. 1, an MTPA control method of a permanent magnet synchronous motor is provided, including the following steps:

Step 1, acquiring an electromagnetic torque and a stator current of a motor to be controlled, in which the motor to be controlled is a built-in permanent magnet synchronous motor used in an electric aircraft, and an MTPA control module is provided in the built-in permanent magnet synchronous motor. The MTPA control module is configured to control the built-in permanent magnet synchronous motor according to MTPA angles.

It should be explained in detail that the process of acquiring an electromagnetic torque and a stator current of a motor to be controlled is as follows:

Step 11, establishing MTPA control logic rules of the motor to be controlled according to the nonlinear equation of the motor to be controlled. Among them, the nonlinear equation of the motor to be controlled includes the steady-state voltage equation of the motor to be controlled and the torque equation of the motor to be controlled.

Specifically, the steady-state voltage equation of the motor to be controlled is as follows:

$${u}_{d} = {R}_{s} {i}_{d} + {L}_{d} ( {i}_{d} , {i}_{q} ) \frac{{di}_{d}}{dt} - {pw}_{m} {L}_{q} ( {i}_{d} , {i}_{q} ) {i}_{q}$$

$${u}_{q} = {R}_{s} {i}_{q} + {L}_{q} ( {i}_{d} , {i}_{q} ) \frac{{di}_{q}}{dt} + {pw}_{m} {L}_{d} ( {i}_{d} , {i}_{q} ) {i}_{d} + {pw}_{m} {φ}_{f} ( {i}_{d} , {i}_{q} )$$

$${i}_{d} = - {i}_{s} sin θ$$

$${i}_{q} = {i}_{s} cos θ$$

where u_{d} is the equivalent voltage of the motor to be controlled on the direct axis; Rₛ is the stator resistance of the motor to be controlled; la is the equivalent current of the motor to be controlled on the direct axis; L_{d} is the equivalent inductance of the motor to be controlled on the direct axis; i_{q} is the equivalent current of the motor to be controlled on the quadrature axis; t is the time; p is the number of pole pairs of the motor to be controlled; wₘ is the mechanical rotor speed of the motor to be controlled; L_{q} is the equivalent inductance of the motor to be controlled on the quadrature axis; u_{q} is the equivalent voltage of the motor to be controlled on the quadrature axis; Of is the permanent magnet flux linkage of the motor to be controlled; iₛ is the stator current of the motor to be controlled; and θ is the current angle of the motor to be controlled.

Specifically, the torque equation of the motor to be controlled is as follows:

$${T}_{e} = \frac{3}{2} p \{ {φ}_{f} ( {i}_{d} , {i}_{q} ) {i}_{q} + [ {L}_{d} ( {i}_{d} , {i}_{q} ) - {L}_{q} ( {i}_{d} , {i}_{q} ) ] {i}_{d} {i}_{q} \}$$

$${T}_{e} = 1.5 {pi}_{s} ( {φ}_{f} cos θ - 0.5 ( {L}_{d} - {L}_{q} ) {i}_{s} sin 2 θ )$$

where Tₑ is the electromagnetic torque of the motor to be controlled.

It should be noted that the nonlinear equation of the motor to be controlled can reflect the complex electromagnetic relationship inside the motor to be controlled, such as the interaction between electromagnetic torque, stator current, permanent magnet flux, and current angle. Since the MTPA control strategy of a permanent magnet synchronous motor aims to achieve high-efficiency operation of the permanent magnet synchronous motor under different operating conditions, by reasonably distributing direct axis current and quadrature axis current, the current consumed by the permanent magnet synchronous motor when outputting the same torque is minimized, thereby improving the efficiency and performance of the permanent magnet synchronous motor. Based on the nonlinear equation of the motor to be controlled, the MTPA control logic rules of the motor to be controlled are established, which can accurately determine the current distribution strategy according to the real-time operating status of the motor, and provide a theoretical basis and control criteria for accurately obtaining electromagnetic torque and stator current; secondly, based on the MTPA control logic rules of the motor to be controlled, the current distribution of the motor to be controlled can be dynamically adjusted according to the torque and speed requirements of the electric aircraft for the motor to be controlled under different operating conditions, ensuring efficient and stable operation of the motor and meeting the power requirements of the electric aircraft.

Step 12, acquiring an electromagnetic torque and a stator current of a motor to be controlled based on a preset current angle test value according to the MTPA control logic rules of the motor to be controlled. Specifically, according to the MTPA control logic rules of the motor to be controlled, the preset current angle test value is used as a test signal, and data is collected from the controller speed loop and torque sensor of the motor to be controlled respectively to obtain the electromagnetic torque and stator current of the motor to be controlled, in which when collecting data from the controller speed loop of the motor to be controlled, the stator current of the motor to be controlled can be obtained; when collecting data from the torque sensor of the motor to be controlled, the electromagnetic torque of the motor to be controlled can be obtained.

It should be noted that the controller speed loop of the motor to be controlled is set in a control module of the motor to be controlled and is associated with the drive circuit of the motor to be controlled. The working principle of the controller speed loop includes: The controller speed loop collects the speed information of the motor to be controlled in real time based on a feedback control theory and compares it with a preset speed reference value; when the speed information of the motor to be controlled collected in real time deviates from the preset speed reference value, the controller speed loop will adjust the output control signal according to a preset control method, thereby changing the input current of the motor to maintain the speed stability of the motor to be controlled; when collecting data from the controller speed loop of the motor to be controlled, since the controller speed loop has the characteristic of controlling the motor current, the stator current of the motor to be controlled can be obtained by analyzing and calculating the control signal output by the controller speed loop.

It should further be noted that the torque sensor of the motor to be controlled is installed between the output shaft of the motor to be controlled and the external load, which can accurately measure the torque transmitted by the output shaft of the motor to be controlled. Preferably, the torque sensor of the motor to be controlled is a strain gauge torque sensor. The working principle of a strain gauge torque sensor includes: When the motor to be controlled is operating, the output shaft will generate torque. The strain gauge torque sensor converts the torque into an electrical signal output based on the resistance strain effect, and the electromagnetic torque of the motor to be controlled can be obtained.

Step 2, establishing a current angle objective function of the motor to be controlled with the goal of maximizing the ratio of the electromagnetic torque to the stator current of the motor to be controlled. Among them, the current angle objective function of the motor to be controlled is as follows:

$$\{ \begin{matrix}f ( θ ) = \frac{{T}_{e}}{{i}_{s}} \\ {max}_{θ} \frac{{T}_{e}}{{i}_{s}} \\ s . t . 0 \leq θ \leq π / 2\end{matrix}$$

where f(θ) is the current angle objective function of the motor to be controlled; θ is the current angle of the motor to be controlled; Tₑ is the electromagnetic torque of the motor to be controlled; and iₛ is the stator current of the motor to be controlled.

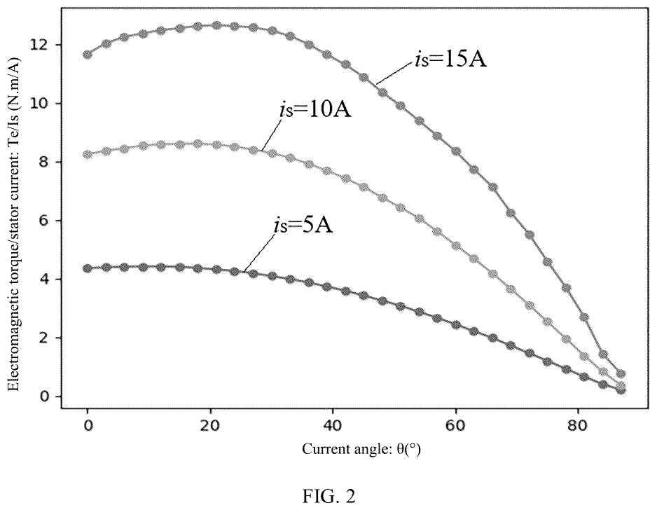

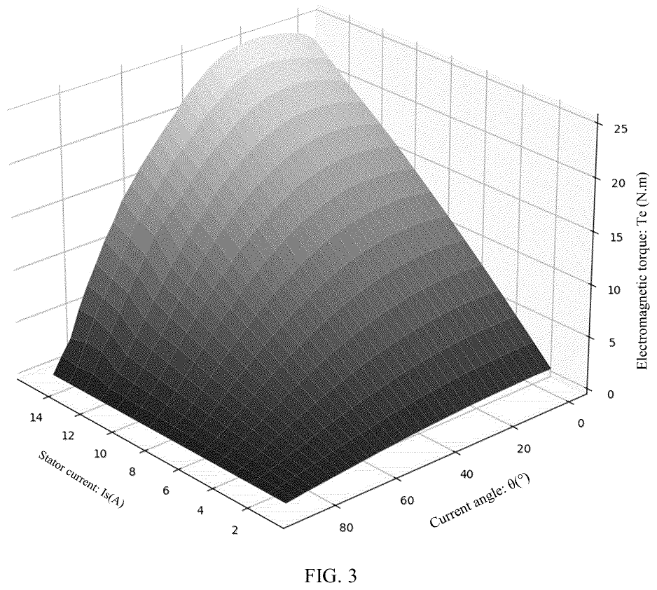

It should be noted that in the built-in permanent magnet synchronous motor, both the permanent magnet torque and the reluctance torque depend on the current angle. For a given stator current, the electromagnetic torque of the built-in permanent magnet synchronous motor serves as a function of the current angle; among them, in the process of increasing the current angle from 0 to π/2, the function curve of the current angle shows a trend of first increasing and then decreasing, as shown in FIGS. 2-3. FIG. 2 shows a schematic diagram of a two-dimensional increase and decrease trend of the current angle, and FIG. 3 shows a schematic diagram of a three-dimensional increase and decrease trend of the current angle. As can be seen from FIG. 2, when the stator current is 5 A, 10 A, and 15 A, the function curves of the current angle all show a trend of first increasing and then decreasing. Moreover, it has been proved through actual measurement experiments that the trend of the function curve of the current angle first increasing and then decreasing is established under different conditions, as shown in FIG. 3. Therefore, there is a specific current angle that can maximize the function of the current angle, that is, when the ratio of the electromagnetic torque to the stator current of the motor to be controlled is maximized, a current angle objective function of the motor to be controlled is established. Based on the extreme value theorem, the vertex of the current angle objective function of the motor to be controlled is the optimal current angle of the motor to be controlled.

Step 3, performing a polynomial fitting on the current angle objective function of the motor to be controlled based on Taylor expansion to obtain a polynomial description of the current angle objective function. Among them, the polynomial description of the current angle objective function is as follows:

$$f ( θ ) = \frac{{T}_{e}}{{i}_{s}} = {a}_{k} {θ}^{k} + {a}_{k - 1} {θ}^{k - 1} + … + {a}_{1} θ + {a}_{0} , θ ∈ [ 0 , \frac{π}{2} ]$$

where aₖ is the coefficient of the k-order expansion term in the polynomial description of the current angle objective function; aₖ₋₁ is the coefficient of the k−1-order expansion term in the polynomial description of the current angle objective function; ajis the coefficient of the first-order expansion term in the polynomial description of the current angle objective function; a₀ is the coefficient of the zeroth-order expansion term in the polynomial description of the current angle objective function; k is the expansion order, and k∈[0, k].

Specifically, in the process of performing a polynomial fitting on the current angle objective function of the motor to be controlled based on Taylor expansion to obtain a polynomial description of the current angle objective function, the least squares method or a predefined error function method is used for Taylor expansion to perform polynomial fitting on the current angle objective function of the motor to be controlled.

The process of Taylor expansion using the least squares method is applicable to low-order cases with an expansion order of 2 or 3; among them, the process of Taylor expansion using the least squares method is as follows:

$$f ( θ ) = \{ \begin{matrix}- \frac{{a}_{1}}{{a}_{2}} , & k = 2 \\ \frac{- {a}_{2} \pm \sqrt{{a}_{2}^{2} - 3 {a}_{3} {a}_{1}}}{3 {a}_{3}} ∈ [ 0 , \frac{π}{2} ] , & k = 3\end{matrix}$$

where a₁ is the coefficient of the first-order expansion term in the polynomial description of the current angle objective function; a₂ is the coefficient of the second-order expansion term in the polynomial description of the current angle objective function; and a₃ is the coefficient of the second-order expansion term in the polynomial description of the current angle objective function.

The Taylor expansion based on the predefined error function method is suitable for high-order cases with an expansion order greater than 3; among them, the process of Taylor expansion based on the predefined error function method is as follows:

Based on a preset current angle test value, the preset performance parameters of the motor to be controlled are calculated, in which the preset performance parameters of the motor to be controlled are such as electromagnetic power or motor efficiency. According to the preset current angle test value and the preset performance parameters of the motor to be controlled, an error function is built to obtain a predefined error function. The partial derivatives of the predefined error function with respect to the coefficients of the expansion terms are calculated and set to zero, resulting in a system of linear equations. Solve the linear equations to obtain coefficients of the expansion terms in the polynomial description of the current angle objective function. Finally, according to coefficients of the expansion terms in the polynomial description of the current angle objective function, the polynomial description of the current angle objective function can be obtained.

Among them, the predefined error function is as follows:

$$E ( {a}_{0} , {a}_{1} , … , {a}_{k} ) = {\sum }_{i = 1}^{n} {( {y}_{i} - ( {a}_{0} + {a}_{1} {x}_{i} + {a}_{2} {x}_{i}^{2} + … + {a}_{k} {x}_{i}^{k} ) )}^{2}$$

where, E(a₀, a₁, . . . , aₖ) is a predefined error function; xᵢ is the ith preset current angle test value; yᵢ is the preset performance parameter of the motor to be controlled calculated based on the ith preset current angle test value; and n is the number of preset current angle test values.

Step 4, explicitly describing the polynomial description of the current angle objective function according to the Kolmogorov-Arnold Networks to obtain an interpretable objective function. Among them, the interpretable objective function is as follows:

$$g ( θ ) = \frac{{T}_{e}}{{i}_{s}} = {b}_{1} {θ}^{3} + {b}_{2} sin ( θ ) + {b}_{3} exp ( θ ) , θ ∈ [ 0 , \frac{π}{2} ]$$

where g(θ) is the interpretable objective function; b₁ is a parameter describing the current angle objective function baseline, used to reflect the characteristics of the current angle objective function in the basic state, so as to determine the basic direction and approximate range of the current angle objective function; b₂ is a parameter describing the harmonic and periodic behavior of a motor model, used to quantify the influence of the harmonic and periodic characteristics generated by the motor during operation on the current angle objective function; b₃ is a parameter describing the influence of magnetic saturation on the motor model and characterize the effect of magnetic saturation degree on the current angle objective function.

Specifically, the process of explicitly describing the polynomial description of the current angle objective function according to the Kolmogorov-Arnold Networks to obtain an interpretable objective function is as follows:

Based on coefficients of the expansion terms in the polynomial description of the current angle objective function and the preset sample data, a feature vector is built, in which the preset sample data includes the current angle of the motor to be controlled and the electromagnetic torque of the motor to be controlled; the eigenvectors are input into the Kolmogorov-Arnold Networks, and the parameter b₁ describing the current angle objective function baseline, the parameter b₂ describing the harmonic and periodic behavior of the motor model, and the parameter b₃ describing the magnetic saturation effect of the motor model in the interpretable objective function are fitted.

It should be noted that a polynomial is used to model the current angle objective function of the motor to be controlled, and based on preset experimental data, a curve fitting is performed using the Kolmogorov-Arnold Networks to identify parameters in an interpretable objective function. When the current angle objective function of the motor to be controlled is expressed in the form of a polynomial, and the polynomial description of the current angle objective function is explicitly described by the Kolmogorov-Arnold Networks, the optimal current angle of the motor to be controlled can be analyzed.

It should be further noted that in the process of inputting eigenvectors into the Kolmogorov-Arnold Networks, and fitting the parameter b₁ describing the current angle objective function baseline, the parameter b₂ describing the harmonic and periodic behavior of the motor model, and the parameter b₃ describing the magnetic saturation effect of the motor model in the interpretable objective function, the error between the output of the Kolmogorov-Arnold Networks and the parameter target curve is calculated by a back propagation algorithm. The parameters of the Kolmogorov-Arnold Networks are adjusted according to the error, and carry out continuous iteration until the error converges to a preset range. Among them, the parameter target curve is a target curve of the coefficients of the expansion terms in the polynomial description of the current angle objective function and the parameter b₁ describing the current angle objective function baseline, the parameter b₂ describing the harmonic and periodic behavior of the motor model, and the parameter b₃ describing the magnetic saturation effect of the motor model.

Step 5, solving the interpretable objective function to obtain an optimal current angle of the motor to be controlled. Specifically, the process of solving the interpretable objective function to obtain an optimal current angle of the motor to be controlled includes:

Step 51, solving a first-order derivative of the interpretable objective function to obtain the first-order derivative of the objective function with respect to the current angle.

Step 52, letting the first-order derivative of the objective function with respect to the current angle be zero, namely, letting

$$\frac{\partial g ( θ )}{\partial θ} = 0 ,$$

and calculating the optimal current angle for the motor to be controlled.

Step 6, performing MTPA control on the motor to be controlled based on the optimal current angle of the motor to be controlled. Specifically, input the optimal current angle of the motor to be controlled to the MTPA control module of the motor to be controlled, and perform MTPA control on the motor to be controlled.

The MTPA control method for a permanent magnet synchronous motor according to Embodiment 1 accurately calculates an optimal current angle of the motor to be controlled, and performs MTPA control on the motor to be controlled based on the optimal current angle, so as to output torque under the optimized stator current, realize efficient MTPA control, and effectively reduce the additional loss caused by a high-frequency signal injection method. Specifically, the Kolmogorov-Arnold Networks are used to quickly and accurately describe the polynomial description of the current angle objective function explicitly, which can effectively overcome the traditional MTPA control method's reliance on complex mathematical models and signal injection techniques, and avoid the problems of low computational efficiency, poor interpretability, and difficulty in scaling.

In Embodiment 1, the relationship between the optimal current angle and the motor parameters can be fitted in a more intuitive way by using the multilayer nonlinear activation function structure of the Kolmogorov-Arnold Networks. Specifically, each layer of the nonlinear activation function of the Kolmogorov-Arnold Networks can transform the input data to gradually extract key features in the input data. For example, the first layer extracts the basic linear relationship characteristics of current and torque, and the second layer explores the nonlinear relationship characteristics between the basic linear relationship characteristics of current and torque and the optimal current angle based on the first layer. The relationship between the complex motor parameters and the optimal current angle is gradually decomposed and presented in a progressive manner. Moreover, the Kolmogorov-Arnold Networks allow for a clear understanding of the control laws of motors, thereby improving interpretability.

Second, the architecture of the Kolmogorov-Arnold Networks allow for the addition or subtraction of layers and neurons to accommodate motor control tasks of varying complexity. When determining the number of layers, for simple motor control tasks, such as the control of small low-power permanent magnet synchronous motors, the number of layers of the Kolmogorov-Arnold Networks is set to 2-3; for complex motor control tasks, such as the control of large high-power permanent magnet synchronous motors under variable operating conditions, the number of layers of the Kolmogorov-Arnold Networks is set to 4-5 or more to fully extract and process complex features. When determining the number of neurons, a preliminary setting is made based on the dimension of the input data and the complexity of the task. For example, for a case where the input data dimension is low and the task is relatively simple, the number of neurons per layer can be set to be small, such as 10-20. For situations where the input data dimension is high and the task is complex, the number of neurons per layer can be increased accordingly, such as 50-100. Then, through the cross-validation method, training is performed at different neuron number settings, and the best performance neuron number configuration is selected based on the training results. Flexibly adapt the architecture of the Kolmogorov-Arnold Networks to a variety of motor control scenarios from simple to complex, including but not limited to permanent magnet synchronous motors of different power levels and types. In addition, the network parameters of the Kolmogorov-Arnold Networks can be adjusted by preset machine learning methods to adapt to new control needs and environmental changes, further enhancing the scalability of the method.

Compared with the traditional MTPA control method based on signal injection, the method described in Embodiment 1 can greatly reduce the computational complexity and the amount of test data required. Secondly, the Kolmogorov-Arnold Networks can quickly learn and fit an interpretable objective function from a small amount of test data, thereby reducing the number and cost of real vehicle testing. In addition, the Kolmogorov-Arnold Networks can respond to control needs in real time and provide a fast means of estimating the optimal current angle to meet the requirements of electric aircraft that require fast dynamic response.

### Embodiment 2

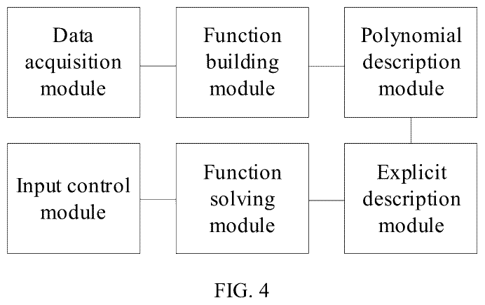

As shown in FIG. 4, Embodiment 2 provides an MTPA control system for a permanent magnet synchronous motor, including a data acquisition module, a function building module, a polynomial description module, an explicit description module, a function solving module, and an input control module.

The data acquisition module is configured for acquiring an electromagnetic torque and a stator current of a motor to be controlled; the function building module is configured for establishing a current angle objective function of the motor to be controlled with the goal of maximizing the ratio of the electromagnetic torque to the stator current of the motor to be controlled; the polynomial description module is configured for performing a polynomial fitting on the current angle objective function of the motor to be controlled based on Taylor expansion to obtain a polynomial description of the current angle objective function; the explicit description module is configured for explicitly describing the polynomial description of the current angle objective function according to the Kolmogorov-Arnold Networks to obtain an interpretable objective function; the function solving module is configured for solving the interpretable objective function to obtain an optimal current angle of the motor to be controlled; and the input control module is configured for performing MTPA control on the motor to be controlled based on the optimal current angle of the motor to be controlled.

### Embodiment 3

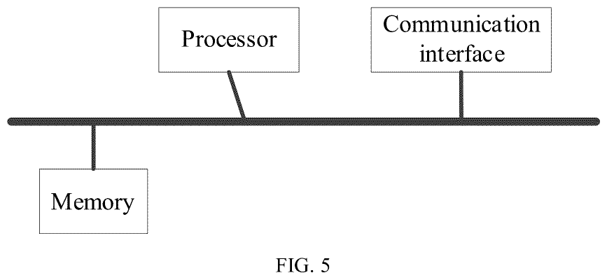

As shown in FIG. 5, Embodiment 3 provides an electronic device, including: a memory for storing a computer program; and a processor for implementing the steps of the MTPA control method of a permanent magnet synchronous motor when executing the computer program.

The steps of implementing the MTPA control method of the preceding permanent magnet synchronous motor when the processor executes the computer program include:
acquiring an electromagnetic torque and a stator current of a motor to be controlled. Among them, the motor to be controlled is a permanent magnet synchronous motor, and an MTPA control module is provided in the motor to be controlled. A current angle objective function of the motor to be controlled is established with the goal of maximizing the ratio of the electromagnetic torque to the stator current of the motor to be controlled; a polynomial fitting on the current angle objective function of the motor to be controlled is performed based on Taylor expansion to obtain a polynomial description of the current angle objective function; the polynomial description of the current angle objective function is explicitly described according to the Kolmogorov-Arnold Networks to obtain an interpretable objective function; the interpretable objective function is solved to obtain an optimal current angle of the motor to be controlled; and the MTPA control on the motor to be controlled is performed based on the optimal current angle of the motor to be controlled.

Alternatively, the processor implements the functions of each module in the MTPA control system of the preceding permanent magnet synchronous motor when executing the computer program, for example:

The data acquisition module is configured for acquiring an electromagnetic torque and a stator current of a motor to be controlled; the function building module is configured for establishing a current angle objective function of the motor to be controlled with the goal of maximizing the ratio of the electromagnetic torque to the stator current of the motor to be controlled; the polynomial description module is configured for performing a polynomial fitting on the current angle objective function of the motor to be controlled based on Taylor expansion to obtain a polynomial description of the current angle objective function; the explicit description module is configured for explicitly describing the polynomial description of the current angle objective function according to the Kolmogorov-Arnold Networks to obtain an interpretable objective function; the function solving module is configured for solving the interpretable objective function to obtain an optimal current angle of the motor to be controlled; and the input control module is configured for performing MTPA control on the motor to be controlled based on the optimal current angle of the motor to be controlled.

Exemplarily, the computer program can be divided into one or more modules/units, which are stored in the memory and executed by the processor to complete the present disclosure. The one or more modules/units may be a series of computer program instruction segments capable of performing preset functions, and the instruction segments are used to describe the execution process of the computer program in the electronic device.

For example, the computer program can be divided into a data acquisition module, a function building module, a polynomial description module, an explicit description module, a function solving module and an input control module. The specific functions of each module are as follows: The data acquisition module is configured for acquiring an electromagnetic torque and a stator current of a motor to be controlled; the function building module is configured for establishing a current angle objective function of the motor to be controlled with the goal of maximizing the ratio of the electromagnetic torque to the stator current of the motor to be controlled; the polynomial description module is configured for performing a polynomial fitting on the current angle objective function of the motor to be controlled based on Taylor expansion to obtain a polynomial description of the current angle objective function; the explicit description module is configured for explicitly describing the polynomial description of the current angle objective function according to the Kolmogorov-Arnold Networks to obtain an interpretable objective function; the function solving module is configured for solving the interpretable objective function to obtain an optimal current angle of the motor to be controlled; and the input control module is configured for performing MTPA control on the motor to be controlled based on the optimal current angle of the motor to be controlled.

The electronic device can be a computing device such as a desktop computer, a notebook, a PDA, or a cloud server. The electronic device may include, but is not limited to, a processor and a memory. Those skilled in the art can understand that the above are examples of electronic devices and do not constitute a limitation on electronic devices. They may include more components than the above, or combine certain components, or different components. For example, the electronic device may further include input and output devices, network access devices, buses, and so on.

The processor can be a central processing unit (CPU), or other general-purpose processors, digital signal processors (DSP), application specific integrated circuits (ASIC), field-programmable gate array (FPGA) or other programmable logic devices, discrete gate or transistor logic devices, discrete hardware components, and so on. The general-purpose processor can be a microprocessor or any conventional processor, and so on. The processor is the control center of the electronic device and uses various interfaces and lines to connect various parts of the entire electronic device.

The memory can be used to store the computer program and/or modules, and the processor realizes various functions of the electronic device by running or executing the computer program and/or modules stored in the memory and calling the data stored in the memory.

The memory may mainly include a storage program area and a storage data area, in which the storage program area can store an operating system, application programs required for at least one function (such as sound playback function, image playback function, and so on); the storage data area can store data created according to the use of a mobile phone (such as audio data, phone book, and so on). In addition, the memory may include a high-speed random access memory and may further include non-volatile memories such as hard disks, memory, plug-in hard disks, smart media cards (SMC), secure digital (SD) cards, flash cards, at least one disk storage device, flash memory devices, or other volatile solid-state storage devices.

### Embodiment 4

Embodiment 4 further provides a computer-readable storage medium. The computer-readable storage medium stores a computer program, and when the computer program is executed by the processor, steps of the MTPA control method of the permanent magnet synchronous motor are realized.

The module/unit integrated with the MTPA control system of the permanent magnet synchronous motor can be stored in a computer-readable storage medium if it is implemented in the form of a software functional unit and sold or used as an independent product.

Based on this understanding, the present disclosure implements all or part of the process in the MTPA control method of the preceding permanent magnet synchronous motor, which can further be completed by instructing related hardware through a computer program. The computer program can be stored in a computer-readable storage medium. When executed by a processor, the computer program can implement the steps of the MTPA control method of the preceding permanent magnet synchronous motor. Among them, the computer program includes a computer program code, which can be in source code form, object code form, executable file or preset intermediate form, and so on.

The computer-readable storage medium may include: any entity or device, recording medium, USB flash drive, mobile hard disk, magnetic disk, optical disk, computer memory, read-only memory (ROM), random access memory (RAM), electric carrier signal, telecommunication signal and software distribution medium that can carry the computer program code.

The preceding embodiment is only one of the implementation methods that can realize the technical solution of the present disclosure. The scope of protection claimed by the present disclosure is not only limited by this embodiment, but further includes any changes, replacements, and other implementation methods that are easy to think of by technicians familiar with this technical field within the technical scope disclosed in the present disclosure.

What is claimed is:

1. An MTPA control method for a permanent magnet synchronous motor, comprising:
acquiring an electromagnetic torque and a stator current of a motor to be controlled;
establishing a current angle objective function of the motor to be controlled with the goal of maximizing the ratio of the electromagnetic torque to the stator current of the motor to be controlled;
performing a polynomial fitting on the current angle objective function of the motor to be controlled based on Taylor expansion to obtain a polynomial description of the current angle objective function;
explicitly describing the polynomial description of the current angle objective function according to the Kolmogorov-Arnold Networks to obtain an interpretable objective function, wherein the interpretable objective function is as follows:
$$g ( θ ) = \frac{{T}_{e}}{{i}_{s}} = {b}_{1} {θ}^{3} + {b}_{2} sin ( θ ) + {b}_{3} exp ( θ ) , θ ∈ [ 0 , \frac{π}{2} ]$$
where g(θ) is the interpretable objective function; θ is the current angle of the motor to be controlled; Tₑ is the electromagnetic torque of the motor to be controlled; iₛ is the stator current of the motor to be controlled; b₁ is the parameter describing the current angle objective function baseline; b₂ is the parameter describing the harmonic and periodic behavior of the motor model; b₃ is the parameter describing the magnetic saturation effect of the motor model;
solving the interpretable objective function to obtain an optimal current angle of the motor to be controlled; and
performing MTPA control on the motor to be controlled based on the optimal current angle of the motor to be controlled.

2. The MTPA control method of a permanent magnet synchronous motor according to claim 1, wherein the process of acquiring an electromagnetic torque and a stator current of a motor to be controlled comprises:
establishing MTPA control logic rules of the motor to be controlled according to the nonlinear equation of the motor to be controlled; and
acquiring an electromagnetic torque and a stator current of a motor to be controlled based on a preset current angle test value according to the MTPA control logic rules of the motor to be controlled.

3. The MTPA control method of a permanent magnet synchronous motor according to claim 2, wherein the nonlinear equation of the motor to be controlled includes the steady-state voltage equation of the motor to be controlled and the torque equation of the motor to be controlled;
the steady-state voltage equation of the motor to be controlled is as follows:
$${u}_{d} = {R}_{s} {i}_{d} + {L}_{d} ( {i}_{d} , {i}_{q} ) \frac{{di}_{d}}{dt} - {pw}_{m} {L}_{q} ( {i}_{d} , {i}_{q} ) {i}_{q}$$
$${u}_{q} = {R}_{s} {i}_{q} + {L}_{q} ( {i}_{d} , {i}_{q} ) \frac{{di}_{q}}{dt} + {pw}_{m} {L}_{d} ( {i}_{d} , {i}_{q} ) {i}_{d} + {pw}_{m} {φ}_{f} ( {i}_{d} , {i}_{q} )$$
$${i}_{d} = - {i}_{s} sin θ$$
$${i}_{q} = {i}_{s} cos θ$$
where, u_{d} is the equivalent voltage of the motor to be controlled on the direct axis; Rₛ is the stator resistance of the motor to be controlled; i_{d} is the equivalent current of the motor to be controlled on the direct axis; L_{d} is the equivalent inductance of the motor to be controlled on the direct axis; i_{q} is the equivalent current of the motor to be controlled on the quadrature axis; t is time; p is the number of pole pairs of the motor to be controlled; wₘ is the mechanical rotor speed of the motor to be controlled; L_{q} is the equivalent inductance of the motor to be controlled on the quadrature axis; u_{q} is the equivalent voltage of the motor to be controlled on the quadrature axis; φ_{f} is the permanent magnet flux linkage of the motor to be controlled; iₛ is the stator current of the motor to be controlled; θ is the current angle of the motor to be controlled;
the torque equation of the motor to be controlled is as follows:
$${T}_{e} = \frac{3}{2} p \{ {φ}_{f} ( {i}_{d} , {i}_{q} ) {i}_{q} + [ {L}_{d} ( {i}_{d} , {i}_{q} ) - {L}_{q} ( {i}_{d} , {i}_{q} ) ] {i}_{d} {i}_{q} \}$$
$${T}_{e} = 1.5 {pi}_{s} ( {φ}_{f} cos θ - 0.5 ( {L}_{d} - {L}_{q} ) {i}_{s} sin 2 θ )$$
where Tₑ is the electromagnetic torque of the motor to be controlled.

4. The MTPA control method of a permanent magnet synchronous motor according to claim 1, wherein the current angle objective function of the motor to be controlled is as follows:
$$\{ \begin{matrix}f ( θ ) = \frac{{T}_{e}}{{i}_{s}} \\ {max}_{θ} \frac{{T}_{e}}{{i}_{s}} \\ s . t . 0 \leq θ \leq π / 2\end{matrix}$$
where, f(θ) is the current angle objective function of the motor to be controlled.

5. The MTPA control method of a permanent magnet synchronous motor according to claim 4, wherein the polynomial description of the current angle objective function is as follows:
$$f ( θ ) = \frac{{T}_{e}}{{i}_{s}} = {a}_{k} {θ}^{k} + {a}_{k - 1} {θ}^{k - 1} + … + {a}_{1} θ + {a}_{0} , θ ∈ [ 0 , \frac{π}{2} ]$$
where aₖ is the coefficient of the k-order expansion term in the polynomial description of the current angle objective function; aₖ₋₁ is the coefficient of the k−1-order expansion term in the polynomial description of the current angle objective function; a₁ is the first-order expansion term coefficient in the polynomial description of the current angle objective function; a₀ is the coefficient of the zeroth order expansion term in the polynomial description of the current angle objective function; k is the expansion order, k∈[0, k].

6. The MTPA control method of a permanent magnet synchronous motor according to claim 1, wherein the process of solving the interpretable objective function to obtain an optimal current angle of the motor to be controlled comprises:
solving a first-order derivative of the interpretable objective function to obtain the first-order derivative of the objective function with respect to the current angle; and
letting the first-order derivative of the objective function with respect to the current angle be zero, and calculating the optimal current angle for the motor to be controlled.

7. An MTPA control system for a permanent magnet synchronous motor, comprising:
a data acquisition module, configured for acquiring an electromagnetic torque and a stator current of a motor to be controlled;
a function building module, configured for establishing a current angle objective function of the motor to be controlled with the goal of maximizing the ratio of the electromagnetic torque to the stator current of the motor to be controlled;
a polynomial description module, configured for performing a polynomial fitting on the current angle objective function of the motor to be controlled based on Taylor expansion to obtain a polynomial description of the current angle objective function;
an explicit description module, configured for explicitly describing the polynomial description of the current angle objective function according to the Kolmogorov-Arnold Networks to obtain an interpretable objective function, wherein the interpretable objective function is as follows:
$$g ( θ ) = \frac{{T}_{e}}{{i}_{s}} = {b}_{1} {θ}^{3} + {b}_{2} sin ( θ ) + {b}_{3} exp ( θ ) , θ ∈ [ 0 , \frac{π}{2} ]$$
where g(θ) is the interpretable objective function; θ is the current angle of the motor to be controlled; Tₑ is the electromagnetic torque of the motor to be controlled; iₛ is the stator current of the motor to be controlled; b₁ is the parameter describing the current angle objective function baseline; b₂ is the parameter describing the harmonic and periodic behavior of the motor model; and b₃ is the parameter describing the magnetic saturation effect of the motor model;
a function solving module, configured for solving the interpretable objective function to obtain an optimal current angle of the motor to be controlled; and
an input control module, configured for performing MTPA control on the motor to be controlled based on the optimal current angle of the motor to be controlled.

8. An electronic device, comprising:
a processor, suitable for executing computer programs; and
a computer-readable storage medium; wherein the computer-readable storage medium stores a computer program, and when the computer program is executed by the processor, the MTPA control method of the permanent magnet synchronous motor according to claim 1 is executed.

9. A computer-readable storage medium, the computer-readable storage medium storing a computer program, wherein the computer program implements the MTPA control method of the permanent magnet synchronous motor according to claim 1 when performed by a processor.
